(19) United States
(12) Patent Application Publication
(10) Pub. No.: US 2015/0181449 A1
(43) Pub. Date: Jun. 25, 2015

(54) Method And Apparatus For Monitoring Mobile Communication Networks

(71) Applicant: ALCATEL-LUCENT USA INC., Murray Hill, NJ (US)

(72) Inventors: Nikolai Didenko, Princeton, NJ (US); Kyle McNay, Austin, TX (US)

(73) Assignee: ALCATEL-LUCENT USA INC., Murray Hill, NJ (US)

(21) Appl. No.: 14/139,404

(22) Filed: Dec. 23, 2013

(51) Int. Cl. H04W 24/10; H04W 24/02

(52) U.S. Cl. CPC H04W 24/10; H04W 24/02

(57) ABSTRACT

A manner of monitoring communications networks, and in a preferred embodiment specifically of monitoring and reporting RF (radio frequency) signal strength in mobile communication networks. A mobile device manager generates and transmits one or more measurement request messages and receives network-characteristic measurements in response. These responses are stored and aggregated and may be used to generate network maps and generate alarms as appropriate or at the request of a network operator.

### TECHNICAL FIELD

The present invention relates generally to the field of communication networks, and, more particularly, to a method and apparatus for monitoring and reporting network characteristics such received RF signal strength in a mobile communication network.

### BACKGROUND

The following abbreviations are herewith defined, at least some of which are referred to within the following description of the state-of-the-art and the present invention.
CDMA Code Division Multiple Access
DMS Device Management Server
EVDO Evolution Data Optimized
KMP Knowledge Management Platform
GPS Global positioning system
LTE Long Term Evolution
MDM Mobile Device Manager
RF Radio Frequency
SMP Service Management Platform

Mobile networks, and more specifically mobile access networks, rely on a geographically-dispersed array of base stations, each with an antenna for sending and receiving RF (radio frequency) signals in order to communicate with mobile stations. The base stations are in turn connected with a main or core network, typically using higher-capacity channels such as wire or fiber optic cables, to relay mobile station communications to and from their ultimate destination.

As should be apparent, the mobile stations use the air interface channels to connect to the network so they do not have to operate from a fixed location. Generally speaking, as they travel the mobile station are able to establish a connection with one or more base stations serving their current location. To enhance their portability, the mobile stations are small and therefore have limited battery power. Their transmit power is of course relatively small, and they rely on the availability of a not-too-distant base station to maintain contact with the network.

The quality of the RF signal received by a mobile station is very important. In the early days of cellular telephony, coverage areas were limited, the coverage area being the geographical extent in which contact with a base station is possible. Although coverage has improved dramatically in recent years, there still remain pockets of poor or even no coverage, even within generally well-covered areas.

When the user of a mobile station encounters one of these pockets, the quality of service degrades. Data transmissions may be interrupted or corrupted, voice calls may be dropped. Subscribers routinely experiencing such problems may be inclined to switch to another mobile service provider.

Naturally, service providers are interested in identifying areas of poor coverage so that remedial measures may be attempted. This is easy enough where, for example, a tunnel or major topographic feature regularly blocks effective radio communications. In other situations it may be more difficult, and the cause of the problem not so apparent. Zones of poor coverage may even be intermittent, perhaps when influenced by weather phenomena, traffic, or equipment degradation.

Service providers therefore regularly travel their coverage areas and take measurements of signal quality to identify zones that are problematic. Where the received RF signal strength is below expectations, for example, an investigation may be undertaken. Remedial measures may include equipment upgrade, repair, or replacement. New base stations may even be added where appropriate.

But of course constantly traversing a broad coverage area is not cost-free, and in fact may be quite expensive given the vehicles, labor, and time involved. In addition, some areas, such as private property, parks, and waterways may be more difficult to access even though frequented by network subscribers. There is a need, therefore, for more efficient alternatives.

### SUMMARY

The present invention provides a manner of monitoring communications networks, and in a preferred embodiment specifically of monitoring and reporting RF (radio frequency) signal strength in mobile communication networks. In one aspect, the present provides a method for monitoring a mobile communication network including the operations of transmitting from a mobile device manager a measurement request message, the request message comprising a request that a managed device measure at least one network characteristic, receiving at the mobile device manager a response to the measurement request message, the response comprising a measurement value, associating the measurement value with the location of the managed device, and storing the measurement value and associated location in a measurement database accessible to the mobile device manager.

In some embodiments, the method may also include determining the location of the managed device, for example by receiving an indication of the location in the received response to the measurement request. In other embodiments the location may be determined by reference to a database or by sending a query to the managed device. The method may further include associating a time stamp with the measurement value and storing the associated time stamp in the measurement database.

In some embodiments, the method may also include selecting the at least one network characteristic for measurement, although in a preferred embodiment the network the network characteristic is the strength of a received RF signal at the mobile station. The method may also include selecting at least one managed device as an addressee of a measurement request message. In many implementations, the at least one managed device is a mobile station, and frequent a plurality of managed devices are selected. In some embodiments the plurality of measurement values may be aggregated. The aggregated measurements may be used in creating a measurement map comprising least one measurement value in association with a geographic area. The measurement map may then be presented, for example to a network operator. The measurements received in response to the measurement request message may also be compared to a threshold, and an alarm generated if the value is beyond the threshold.

In another aspect, the present invention is a mobile device manager including a processor, a memory device in communication with the processor, a measurement request message generator configured to generate measurement request messages, a network interface for transmitting measurement request messages and receiving responses to measurement request messages, and a measurement database for storing measurements received in response to measurement request.

In some embodiments of this aspect, the mobile device manager of claim 14 may also include a measurement aggregator configured for extracting measurements contained in responses to measurement request messages and storing them in the measurement database. The measurement aggregator may also be configured for associating a timestamp, a location, or both with an individual measurement.

In some embodiments, the measurement aggregator of the mobile device manager may be further configured for aggregating a plurality of measurements in association with their respective timestamps and locations. Measurements received may be used to create a measurement map, for example using a map generator of the mobile device manager. In some embodiments, the mobile device manager may also include an alarm generator configured for generating an alarm message if one or more measurements pass a measurement threshold.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a simplified schematic diagram illustrating selected components of a mobile network monitoring system according to an embodiment of the present invention;

FIG. 2 is a flow diagram illustrating a method of network monitoring according to an embodiment of the present invention;

FIG. 3 is a flow diagram illustrating a method of network monitoring according to an embodiment of the present invention;

FIG. 4 is a message flow diagram illustrating a process of monitoring a network according to an embodiment of the present invention; and

FIG. 5 is a simplified block diagram illustrating a device management server according to an embodiment of the present invention.

### DETAILED DESCRIPTION

The present invention provides a manner of monitoring communications networks, and in a preferred embodiment specifically of monitoring and reporting RF (radio frequency) signal strength in mobile communication networks.

Unlike a traditional landline network, in a mobile network most user devices are equipped with radio frequency transmitters and receivers so that they can communicate with a nearby base station, which is analogously equipped. As mentioned above, a typical cellular network includes a number of geographically-distributed base stations defining a coverage area.

Within the coverage area, subscribers may for example place and receive telephone calls and text messages or download and upload data using for example a cellular telephone, smartphone, or tablet. For convenience, all such devices will be referred to herein as mobile stations.

Specific operational protocols may vary, but typically a mobile station periodically registers with a local mobile access network by transmitting a signal announcing its presence in the area. The base station or base stations receiving the signal report the mobile station presence to a network database so that network communications to the station may be properly routed.

An RF link will normally be established with one nearby base station, although not necessarily the closest, and this may be used for both uplink and downlink transmissions. The link from the mobile station may be changed to another base station if the mobile station relocates, or for other reasons such as traffic management. Switching from one base station to another is accomplished by a procedure known as handover, preferably with little or no perceptible interruption for the user.

Mobile stations may be generally described as hardware and stored executable program instructions. In the contemporary marketplace, hardware upgrades to existing devices are relatively rare, but software updates to the executable program instructions are both desirable and increasingly common. These upgrades may be performed using an MDM (mobile device manager) or similar device. The MDM may not only periodically perform such upgrades, but detect and even repair defects in the mobile station operation. The MDM has been introduced relatively recently.

MDMs and similar devices use the service provider's cellular access network to manage mobile stations. This largely eliminates the need for subscribers to bring their devices to a service point for upgrades or attempt to download and implement the upgrades themselves. In fact, most management operations may be performed with little or no subscriber involvement.

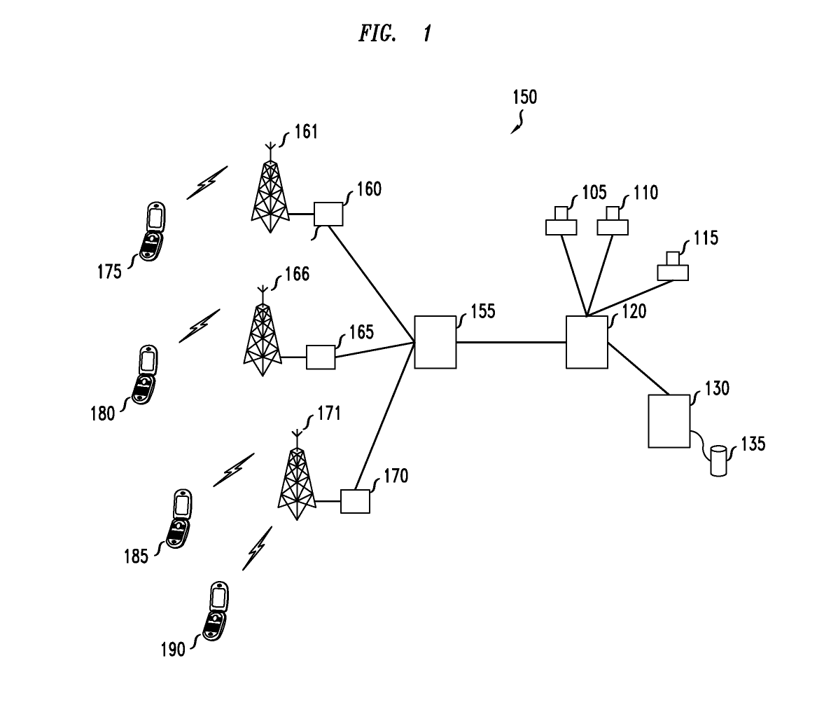

In accordance with the present invention, the MDM may also be used for network monitoring. In a preferred embodiment, the MDM is employed to monitor and report signal strength by exploiting information available to the UE. This embodiment will now be described in detail, beginning with reference to FIG. 1.

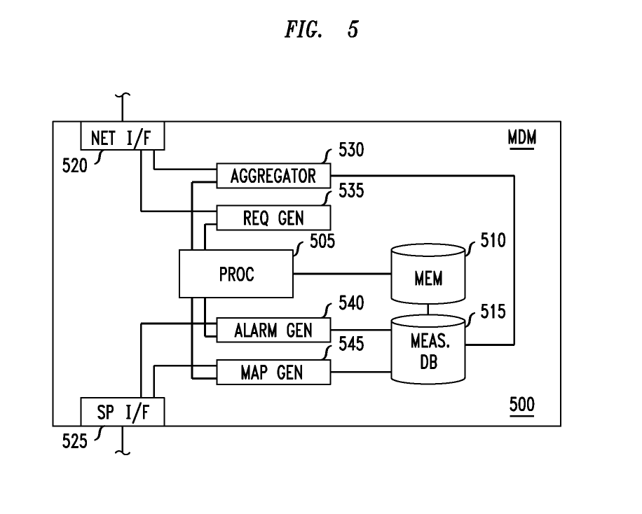

FIG. 1 is a simplified schematic diagram illustrating selected components of a mobile network monitoring system 100 according to an embodiment of the present invention. In this embodiment, system 100 includes a device management server 120 configured according to the present invention (see also FIG. 5). Device management server 120 is in this system 100 in communication with a database server 130 and memory device 135 for storing, organizing, and analyzing the data collected and used by device management server 120. Unless otherwise explicitly stated to the contrary in particular embodiment, memory device 135 is non-transitory in the sense of not being merely a propagating signal.

In the embodiment of FIG. 1, data management server 120 is also in communication with service consoles 105, 110, and 115. Service consoles 105, 110, and 115 (which need not be identically configured) are typically equipped with a display, printer, and user input device for, for example, inputting system requests and data or configuring the system 100. Service consoles may include properly configured personal computers, workstations, tablets, or similar devices.

In this embodiment, device management server 120 is also in communication with a wireless access network 150. Wireless access network 150 is, in most implementations, a cellular mobile access network operated by a service provider. In other implementations, it may be for example a wi-fi or enterprise network, or even a home network. In the embodiment of FIG. 1, wireless access network includes an MSC (mobile switching center) 155 and base stations 160, 165, and 170. Antennas 161, 166, and 171 are associated with respective base stations. Note that other configurations are possible.

Also depicted in FIG. 1 are mobile stations 175, 180, 185, and 190, which are configured to communicate with the wireless access network 150 via an RF link with one of more of antennas 161, 166, and 171. In this embodiment, MSC 155 is in communication with a core or central mobile network (not shown) to which communications outside the group of stations served by the MSC may be directed. Note that although only three base stations are depicted in association with MSC 155, in actual implementations there may be any number.

In accordance with the present invention, device management server 120 is configured to manage the mobile stations in communication with wireless access network 150. In addition, it is configured to monitor conditions within the access network 150, and in a preferred embodiment, to map RF signal strength either locally or throughout the network. This process will now be described in more detail.

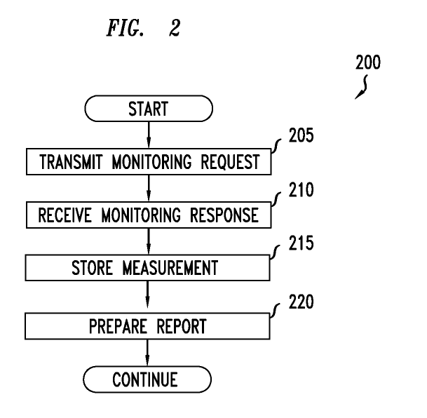

FIG. 2 is a flow diagram illustrating a method 200 of network monitoring according to an embodiment of the present invention. At Start it is presumed that the necessary components are present and configured to be operable at least according to this embodiment. The process then begins when a device management server transmits (step 205) a measurement request to at least one mobile station, the measurement request requesting measurement of at least one network condition.

In this embodiment, the device management server then receives (step 210) a measurement request response from the at least one mobile station. Upon reception of the measurement request response, the device management server stores (step 215) the measurement returned in a database server.

In a preferred embodiment, the measurement is the received RF signal strength, as measured by the at least one mobile station, and the returned RF signal strength measurement is stored along with the time that the measurement was taken (or, alternately, the time of receipt by the device management server) and the location of the mobile device when the measurement was taken.

In this embodiment, the device management server then prepares (step 220) a network status report incorporating the measurement. This report may be presented, for example, at a service console in communication with the device management server. The report may be presented only upon request, or take the form of an alarm, to be presented when the measured characteristic is above or below an established threshold. The report, of course may simply be stored for future reference. The process then continues, if desired, with the sending of additional measurement requests.

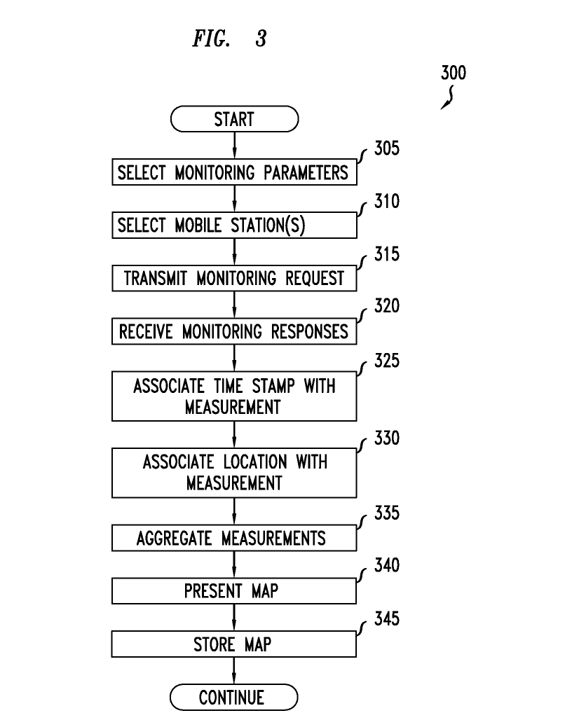

FIG. 3 is a flow diagram illustrating a method 300 of network monitoring according to an embodiment of the present invention. At Start it is presumed that the necessary components are present and configured to be operable at least according to this embodiment. The process then begins when monitoring parameters are selected (step 305). The monitoring parameters may include received signal strength for devices such as mobile stations operating in the network coverage area. The parameters selected may attempt to canvass all devices in the entire area, or may focus on particular areas or devices.

In the embodiment of FIG. 3, at least one mobile device is then selected (step 310), although in most implementations the at least one mobile device will include a number of such devices. The devices may be selected on the basis of model or type, for example, or based on previous upgrades or repairs performed by a device manager. In other situations, devices may be selected based on known or presumed geographic location. Active or registered devices, for example, may be associated with a particular base station, or the device may have recently reported its location.

In still other embodiments, devices may be selected based on the usage pattern associated with the device where an established usage pattern exists. This may include, however, the type of service such as voice or streaming video in which the mobile station is currently participating.

In the embodiment of FIG. 3, the process continues with transmitting a measurement request (step 315) to each of the selected mobile devices. The measurement requests may be sent individually or by multicast. Broadcast messages may also be used, most likely in implementations where the selection of devices that should respond is determinable by the receiving mobile stations.

In the embodiment of FIG. 3, the response or responses from the mobile stations are then received (step 320) in device the management server. Each response should contain the requested measurement or measurements. If not, a new message may be sent to the mobile station in an attempt to gather the data or the mobile station may be dropped from the set of selected mobile stations (not shown). In either event, the non-responsiveness of the mobile station may be noted in the database (also not shown).

In the embodiment of FIG. 3, a time stamp is then associated (step 325) with each measurement received. Preferably, this time stamp is generated by the mobile station taking the measurement and transmitted with the measurement in the measurement request response message. Alternately it may be appended by the device management or data base server. Similarly, a location is associated (step 330) with each measurement. Here, the location is preferably determined by the mobile station using GPS or a similar location system and transmitted with the measurement in the measurement request response message. The location may also be appended by the device management or database server, although in most cases this will be limited to noting the base station through which measurement request response message was transmitted.

In this embodiment, the measurements in the responses are then aggregated (step 335), that is, combined to form an RF signal strength map corresponding to the area in which the queried mobile stations were found. Of course, the RF signal strength map may be drawn using only one or a small number of measurements, which may have value in some instances, but in most cases a larger number of values will be sought to improve the map's accuracy.

In the embodiment of FIG. 3, the map is then presented (step 340) for example at a user console. It may be presented on a display screen or in a format suitable for printing. The presentation may occur on request, whenever a map is prepared, or a combination of both. In one embodiment, the map is presented regardless of request when it is determined (not separately shown) that at least a certain number of measurement values pass a threshold. In the embodiment of FIG. 3, the map is also stored (step 345) for future reference (though not all maps or measurements need be stored, in most cases it is likely that many will). The process then continues as other maps are prepared as necessary or desirable.

Note that the sequence of operation illustrated in FIGS. 2 and 3 represent exemplary embodiments; some variation is possible within the spirit of the invention. For example, additional operations may be added to those shown in FIGS. 2 and 3, and in some implementations one or more of the illustrated operations may be omitted. In addition, the operations of the method may be performed in any logically-consistent order unless a definite sequence is recited in a particular embodiment.

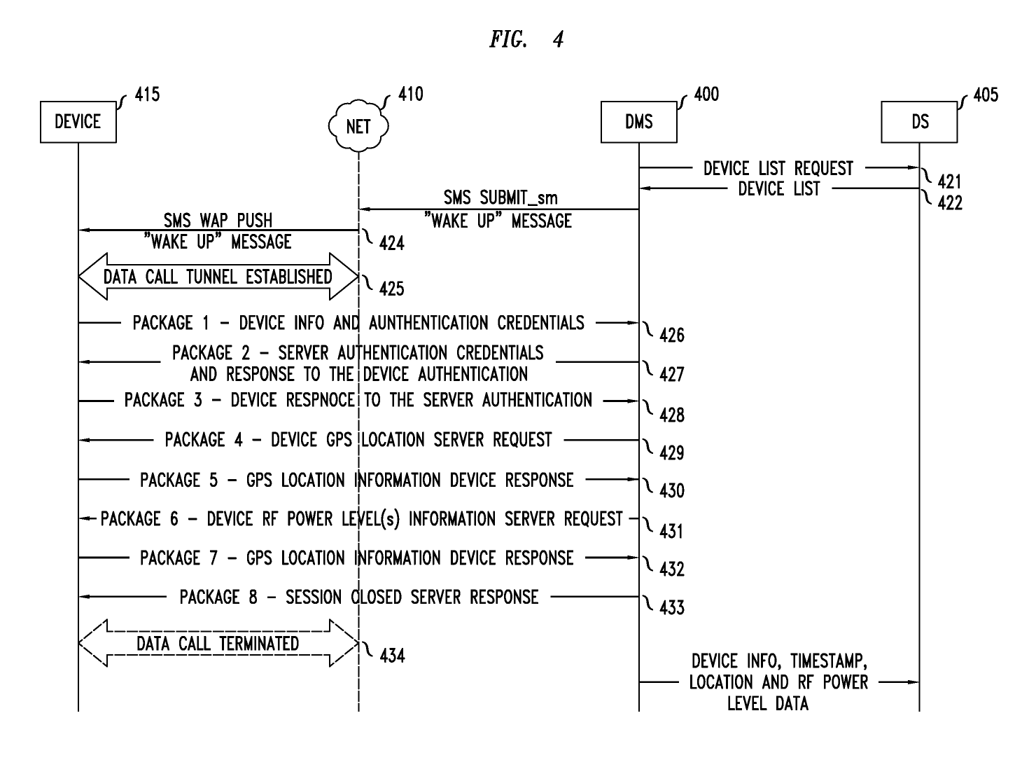

FIG. 4 is a message flow diagram illustrating a process of monitoring a network according to an embodiment of the present invention. Depicted in FIG. 4 are device management server 400 and database server 405 as well as mobile station 415 and wireless access network 410. In this embodiment, the device management server 400 transmits a device list request 421 to database server 405, which responds with a device list 422. This exchange of course relates to the device selection step 310 of method 300, described above. Here it is noted that there may be other ways of selecting the devices and preparing the device list as well.

In the embodiment of FIG. 4, the device management server 400 then sends an SMS Submit_sm “Wake Up” message 423 to the access network 410, which in turn sends an SMS WAP push “Wake Up” message 424 to the mobile station 415. A data call tunnel 425 is then established between mobile station 415 and the access network 410. Note that for convenience only one mobile station is shown, however if there is a plurality of mobile stations on the device list then analogous messages 424 are sent to each of them, and respective data call tunnels 425 established.

In the embodiment of FIG. 4, once the data call 425 tunnel is set up, the mobile station 415 transmits a first package 426 including device information and authentication credentials to the device management server 400. The first package (and subsequent packages in this session) of course is transmitted via access network 410, but which in this embodiment otherwise does not participate in the process.

In this embodiment, a second package 427 including server authentication credentials and response to the device authentication is transmitted from the device management server 400 to the mobile station 415. In a third package 428 the mobile station responds to the server authentication. Note that successful authentication is for convenience presumed in FIG. 4.

In this embodiment, the device management server 400 then transmits a fourth package 429 including a measurement request to the mobile station 415, in this case a device GPS location server request. This request 429 could be omitted, of course, if the device management server 410 already has, for example from a recent prior exchange, knowledge of the location of mobile station 415. In response to the request 429, the mobile station 415 transmits to the device management server 400 a fifth package 430 including a GPS location information device response.

Although not shown in FIG. 4, the device management server may terminate the process with respect to mobile station 415 if there is no location information transmitted, or if the location differs from the location that the device management server may be presently addressing. In this embodiment, it is presumed that the process should continue.

In this embodiment, the device management server 400 then transmits to the mobile station 415 a sixth package 431 including device RF power level information server request. In response the mobile station 415 transmits to the device management server 400 a seventh package 432 including a GPS location information device response. In this embodiment, once the device management server 400 receives the GPS location of the mobile station 415, it send to the mobile station an eighth package 433, which includes a session closed server response, and the data call session 434 is terminated.

In the embodiment of FIG. 4, the device management server 400 then transmits 434 the mobile station device information, time stamp, location, and RF signal strength value to the database server 405, where it is stored for future use.

Note that the sequence of message flow illustrated in FIG. 4 represents an exemplary embodiment; some variation is possible within the spirit of the invention. For example, additional messaging may be added to that shown in FIG. 4, and in some implementations one or more of the illustrated messages may be omitted. In addition, the messages of the method may be transmitted and received in any logically-consistent order unless a definite sequence is recited in a particular embodiment.

FIG. 5 is a simplified block diagram illustrating a device management server 500 according to an embodiment of the present invention. In this embodiment, device management server 500 includes a processor 505 and a memory device 510. Memory device 510 in this embodiment is a physical storage device that may in some cases operate according to stored program instructions. In any case, memory 510 is non-transitory in the sense of not being merely a propagating signal. Memory 510 is used for storing, among other things, data such as a table (not separately shown) of managed devices as well as stored program instructions for execution by processor 505.

Shown separately in FIG. 5 is a measurement database 515, which may be used to store any measurements or other information that has been returned from managed devices as well as aggregations of such data and network maps for presentation. As used herein, a map is an application of a single data point or a data aggregation that is applied to the actual network coverage area so that it may be easily interpreted by an operator. Measurement database 515 may be separate from memory 510, or the two may be integrated. In either case, one or both of memory 510 and measurement data base may be resident on the device management server 500 (as shown in FIG. 5) or be separate but accessible to the processor 505.

In the embodiment of FIG. 5, device management server 500 also includes a request generator 535 for generating measurement request messages and an aggregator 530 for detecting measurements in measurement request response messages and storing them (individually or as an aggregation) in measurement database 515. Aggregator 530 may also perform such functions as associating time stamp and location information with received measurements, selecting certain measurements for inclusion in a particular aggregation, or anonymizing the data to ensure the privacy of subscribers associated with managed devices. Request generator 535 and aggregator 530 may be implemented as hardware or as software program instructions executing on a processor, or a combination of both. They may each or both be integrated with processor 505 or each other, or implemented as separate devices (as depicted in FIG. 5).

In the embodiment of FIG. 5, device management server 500 also includes an alarm generator 540 for generating an alarm message for transmitting, for example, to an operator or service provider. This may occur, for example, when a received measurement or an aggregation of measurements pass a certain threshold. In a preferred embodiment, an alarm message is generated when the RF signal strength reported by a managed device in response to a measurement request message falls below a certain minimum level. Map generator 545 may is configured to generate maps and be used to produce a map applying one or more received measurements to a geographic map for presentation to a service provider or operator. Alarm generator 540 and map generator may be implemented as hardware or as software program instructions executing on a processor, or a combination of both. They may each or both be integrated with processor 505 or each other, or implemented as separate devices (as depicted in FIG. 5).

Finally, in the embodiment of FIG. 5, device management server 500 also includes a network interface 520 for communicating with a network (such as a mobile access network) to, for example, manage devices, and to send measurement request messages and responses. A service provider interface 525 is shown separately in FIG. 5 for communication with, for example, service provider terminals or similar devices.

FIG. 5 illustrates selected components of an embodiment and some variations are described above. Other variations are possible without departing from the claims of the invention as there recited. In some of these embodiments, illustrated components may be integrated with each other or divided into subcomponents. There will often be additional components in the device management server and in some cases less. The illustrations components may also perform other functions in addition to those described above.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A method for monitoring a mobile communication network, comprising:
transmitting from a mobile device manager a measurement request message, the request message comprising a request that a managed device measure at least one network characteristic;
receiving at the mobile device manager a response to the measurement request message, the response comprising a measurement value;
associating the measurement value with the location of the managed device; and
storing the measurement value and associated location in a measurement database accessible to the mobile device manager.

2. The method of claim 1, further comprising determining the location of the managed device.

3. The method of claim 2, wherein determining the location of the managed device comprises receiving an indication of the location in the received response to the measurement request.

4. The method of claim 1, further comprising associating a time stamp with the measurement value and storing the associated time stamp in the measurement database.

5. The method of claim 1, wherein the network characteristic is the strength of a received RF signal at the mobile station.

6. The method of claim 1, further comprising selecting the at least one network characteristic.

7. The method of claim 1, further comprising selecting at least one managed device as an addressee of a measurement request message.

8. The method of claim 7, wherein the at least one managed device is a mobile station.

9. The method of claim 7, wherein the at least one managed device is a plurality of managed devices.

10. The method of claim 9, further comprising aggregating a plurality of measurement values.

11. The method of claim 10, further comprising creating a measurement map comprising least one measurement value in association with a geographic area.

12. The method of claim 11, further comprising presenting the measurement map.

13. The method of claim 1, further comprising comparing a received measurement value to a threshold, and generating an alarm if the value is beyond the threshold.

14. A mobile device manager, comprising:
a processor;
a memory device in communication with the processor;
a measurement request message generator configured to generate measurement request messages;
a network interface for transmitting measurement request messages and receiving responses to measurement request messages; and
a measurement database for storing measurements received in response to measurement request.

15. The mobile device manager of claim 14, further comprising a measurement aggregator configured for extracting measurements contained in responses to measurement request messages and storing them in the measurement database.

16. The mobile device manager of claim 15, wherein the measurement aggregator is further configured for associating a timestamp with an individual measurement.

17. The mobile device manager of claim 15, wherein the measurement aggregator is further configured for associating a location with an individual measurement.

18. The mobile device manager of claim 15, wherein the measurement aggregator is further configured for aggregating a plurality of measurements in association with their respective timestamps and locations.

19. The mobile device manager of claim 15, further comprising a map generator configured for generated a map comprising one or more of the measurements stored in the measurement database.

20. The mobile device manager of claim 15, further comprising an alarm generator configured for generating an alarm message if one or more measurements pass a measurement threshold.
